(19) United States
(12) Patent Application Publication
(10) Pub. No.: US 2024/0256385 A1
(43) Pub. Date: Aug. 1, 2024

(54) DATA STORAGE SYSTEM AND OPERATION METHOD THEREOF

(71) Applicants: SK Hynix Inc., Icheon (KR); Inha University Research and Business Foundation, Incheon (KR)

(72) Inventors: Dayoung LEE, Incheon (KR); Minseok Song, Seoul (KR)

(21) Appl. No.: 18/335,606

(22) Filed: Jun. 15, 2023

(30) Foreign Application Priority Data
Jan. 30, 2023 (KR) 10-2023-0011778

(51) Int. Cl. G06F 11/10

(52) U.S. Cl. CPC G06F 11/1096

(57) ABSTRACT

A data storage system includes a disk array including a plurality of disks storing original data and redundant data that may be used to recover the original data. The data storage system further includes an interface circuit configured to receive a read request for the original data; an input/output (I/O) control circuit configured to provide the disk array with a read request received via the interface circuit; and a redundant data management circuit configured to manage information of the original data and the redundant data. The redundant data management circuit causes parity data, duplicate data, or both to be stored as the redundant data according to a first attribute of the original data, and determines a number of duplicate data according to a second attribute of the original data.

### CROSS-REFERENCE TO RELATED APPLICATION

The present application claims priority under 35 U.S.C. § 119(a) to Korean Patent Application No. 10-2023-0011778, filed on Jan. 30, 2023, which is incorporated herein by reference in its entirety.

### BACKGROUND

### 1. Technical Field

Various embodiments generally relate to a data storage system and an operation method thereof, and more particularly, to a data storage system capable of efficiently managing a data storage space while improving data recovery reliability and an operation method thereof.

### 2. Related Art

Dynamic Adaptive Streaming over HTTP (DASH) technology is a de facto standard technology used by video streaming service providers such as YouTube and Netflix.

DASH technology requires multiple versions of video files with different bitrates. For example, on YouTube, a single video can have more than 20 different bitrate versions.

Due to characteristics of DASH technology, a large-capacity data storage system capable of storing all versions of data is required.

In addition, redundant data is stored to recover data when an error occurs in data or in a physical storage device, which further increases the size of storage space required by the data storage system.

FIG. 1 illustrates a method of managing redundant data where a predetermined number of identical data are stored regardless of a bitrate version and popularity of a video.

FIG. 1 illustrates various types of bitrate versions, where 4K corresponds to the highest bitrate version and 240p corresponds to the lowest bitrate version.

In FIG. 1, video popularity is represented as one of three levels. HOT represents the highest popularity, COLD represents the lowest popularity, and WARM represents the medium popularity.

In FIG. 1, a same number of video data files are stored for each video regardless of bitrate versions and popularity.

In FIG. 1, a white rectangle represents an original video file, and each file may be stored on different disks.

This reduces performance degradation because there is almost no additional overhead during data read operations, but since data is lost when all disks where duplicates are stored fail, mean time to data loss (MTTDL) is low, which results in poor availability.

Because more duplicate data must be stored to prevent data loss, storage space is wasted and the cost is excessively increased.

FIG. 2 illustrates another method for managing redundant data where original data and parity data are stored regardless of a bitrate version and a popularity. A technique such as Reed-Solomon (RS) coding may be used to generate the parity data.

In FIG. 2, a white rectangle represents a partition of a video file, and a black rectangle represent encoded data. These can be stored on different disks, each as a separate file.

For example, an original video may be partitioned into 10 unit data files, and 4 parity files may be generated therefrom, and then each of the partitions may be stored on a separate disk.

In this method, since the required storage space may be reduced and more disks must be damaged before data is lost, the MTTDL value becomes high and a probability of data loss becomes low.

However, since a read operation for a large number of disks and an additional decoding operation must be performed during the data recovery process, overhead increases and performance deteriorates.

### SUMMARY

In accordance with an embodiment of the present disclosure, a data storage system may include a disk array including a plurality of disks and storing original data and redundant data used to recover the original data; an interface circuit configured to receive a read request for the original data; an input/output (I/O) control circuit configured to provide the disk array with a read request received via the interface circuit; a redundant data management circuit configured to manage information of the original data and the redundant data, wherein the redundant data management circuit is configured to store parity data, duplicate data, or both as the redundant data according to a first attribute of the original data, and determines a number of the duplicate data according to a second of the original data.

In accordance with an embodiment of the present disclosure, a method of operating a data storage system may include storing original data in the data storage system; selecting parity data, duplicate data, or both as redundant data according to an attribute of the original data; determining a number of duplicate data according to popularity of the original data; storing the redundant data in the data storage system; and recovering the original data using the redundant data.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIGS. 1 and 2 illustrate conventional techniques for managing redundant data.

FIG. 3 illustrates a data storage system according to an embodiment of the present disclosure.

FIGS. 4 and 5 illustrate respective processes for managing redundant data according to embodiments of the present disclosure.

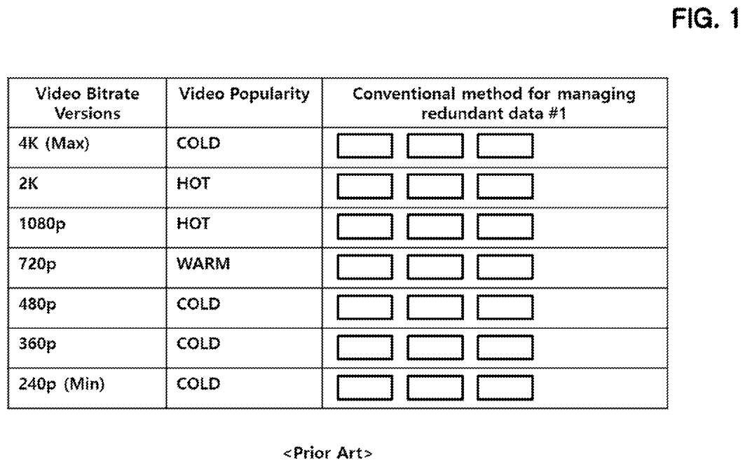

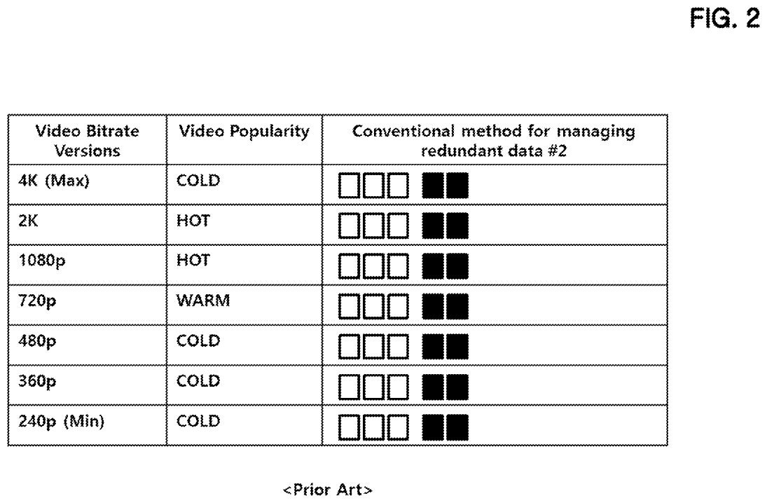

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

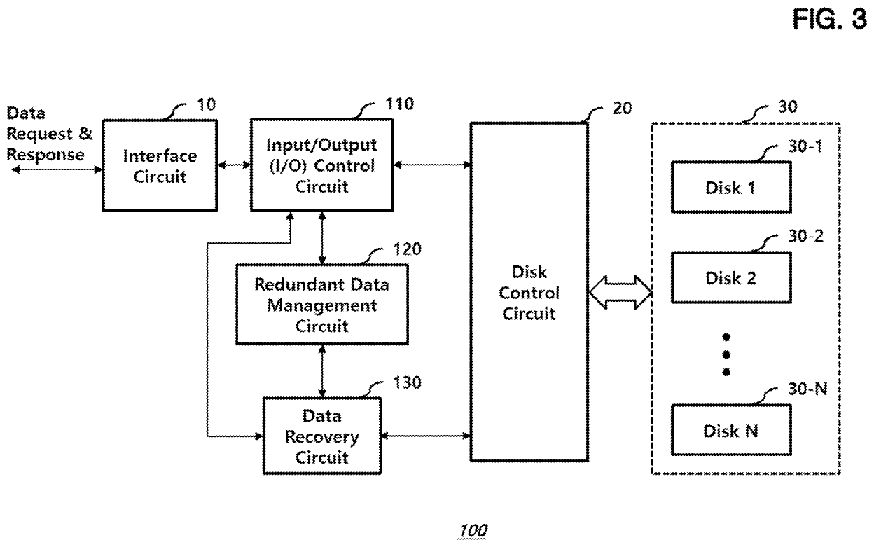

FIG. 3 is a block diagram showing a data storage system 100 according to an embodiment of the present disclosure.

Hereinafter, the data storage system 100 is disclosed in an illustrative context of a server providing a video streaming service including, for example, a plurality of disks for storing video data, but embodiments are not limited thereto.

The data storage system 100 includes an interface circuit 10 that receives a data read or write request and transmits a response thereto, a disk control circuit 20, a disk array 30, an input/output (I/O) control circuit 110, and redundant data management circuit 120, and a data recovery circuit 130.

Since the operation of the I/O control circuit 110 itself, which reads data from the disk array 30 or writes data to the disk array 30 according to a read or write request provided by the interface circuit 10, can be understood easily by a person skilled in the art from a conventional data storage system, a detailed description thereof will be omitted.

In this embodiment, the disk array 30 includes a plurality of disks 30-1, 30-2, . . . , 30-N, where N is a natural number.

Each of the plurality of disks 30-1, 30-2, . . . , 30-N may be a hard disk drive (HDD) or a solid state drive (SSD), but types of disks are not limited thereto.

The disk control circuit 20 controls a read or write operation by controlling a plurality of disks according to a read or write request provided by the I/O control circuit 110.

For example, the disk control circuit 20 may control a plurality of disks included in the disk array 30 according to a RAID technology and may function as a RAID controller.

The redundant data management circuit 120 manages redundant data that is stored redundantly in correspondence with original data.

In this embodiment, data is considered to be a video file, but the data is not limited thereto.

In this embodiment, “redundant data” refers to data that can be used to restore the original data when the original data is damaged.

The redundant data may include one or more duplicate data identical to the original data.

The redundant data may include parity data generated by applying an encoding technique such as RS coding to the original data.

In this embodiment, the redundant data management circuit 120 may select duplicate data or parity data as the redundant data according to data attributes of the data, such as a bitrate version of video data.

In this embodiment, the redundant data management circuit 120 manages popularity of the data by, for example, monitoring a number of data requests (e.g., read requests) for a certain period of time.

The redundant data management circuit 120 determines a type and a number of redundant data in consideration of data attributes. A bitrate version of a data may be represented as a first attribute and a popularity of a data may be represented as a second attribute.

The redundant data management circuit 120 may store information about addresses of the original data therein and manage information about addresses of the redundant data stored in correspondence with the original data.

The address of the original data and the address of the redundant data may be stored in a pre-designated area of the disk array 30.

If an error occurs while the I/O control circuit 110 reads the original data according to an external request, the data recovery circuit 130 may recover the original data and provide the original data to the I/O control circuit 110.

The data recovery circuit 130 may know the type of redundant data corresponding to the original data and the location of redundant data stored in the disk array 30 based on the information provided from the redundant data management circuit 120.

When the redundant data is duplicate data, the data recovery circuit 130 may read the duplicate data and provide it as recovered data.

When the redundant data is parity data, the data recovery circuit 130 may perform a decoding operation using the parity data and provide recovered data recovered through the decoding operation.

The recovered data may be stored in the disk array 30 as the original data, and in this case, the redundant data management circuit 120 may update the address of the original data.

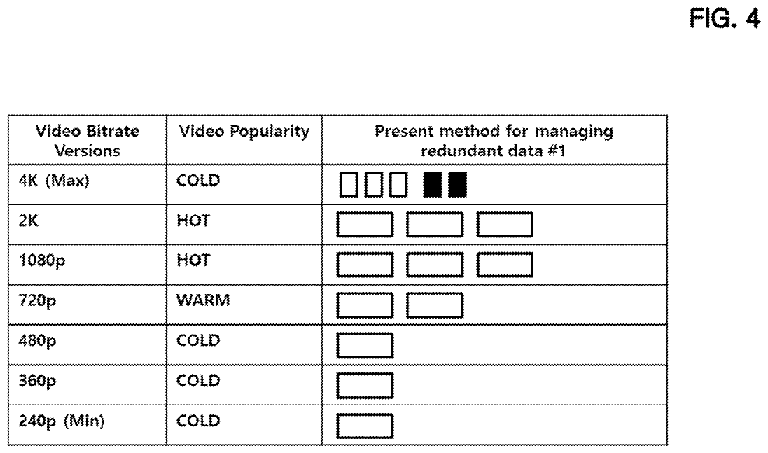

FIG. 4 illustrates a process for managing redundant data according to an embodiment of the present disclosure.

In an embodiment of the present invention, parity data is stored as redundant data for the original data corresponding to the highest bitrate version, where the parity data is generated by encoding the original data according to encoding technique such as RS code. In this case, the highest bitrate version means the highest bitrate version that can be provided by the data storage system 100, and the specific bitrate value of the highest bitrate version may vary depending on embodiments.

In this case, where parity data is used to provide redundancy, the original data may be divided into a plurality of partitions, parity data may be generated for the plurality of partitions, and parity data may be divided into a plurality of partitions. Each partition of the original data and of the parity data may be separately stored on a plurality of disks; for example, each of these partition may be stored on a disk on which no other of these partitions is stored. In this case, the redundant data management circuit 120 may manage an address of each partition of the original data and an address of each partition of the parity data.

In this embodiment, duplicate data are stored as the redundant data for the original data having bitrates lower than the highest bitrate.

In this case, where duplicate data is used to provide redundancy, the number of duplicate data varies according to the popularity of the data.

As described above, the redundant data management circuit 120 monitors numbers of read requests for a certain period of time and manages the popularity of data by classifying the data according to the numbers of read requests into one of three levels in the embodiment.

For example, if the number of requests per hour for a particular piece of data is 10 or more, the popularity of that data may be designated as HOT, if the number of requests is 3 or less, the popularity of that data may be designated as COLD, and if the number of requests per hour is between 4 and 9, the popularity of that data may be designated as WARM.

In the case of FIG. 4, three duplicate data may be stored for data having a HOT attribute, two duplicate data may be stored for data with a WARM attribute, and one duplicate data may be stored for data with a COLD attribute.

In embodiments, when the popularity of data is updated, some of the duplicate data for that data may be deleted or additional duplicate data for that data may be stored.

As described above, the method of storing redundant data using parity data can reduce the possibility of data loss compared to the method of storing duplicate data.

As long as the data of the highest bitrate version is intact, the data of the lower bitrate version can be regenerated by applying transcoding techniques to the data of the highest bitrate version.

Therefore, by applying the present technology, the possibility of data loss of a lower bitrate version for which redundancy may be provided by duplicate data can be improved to the level of data for which redundancy is provided by storing parity data.

In FIG. 4, parity data is stored only for data of the highest bitrate version, but parity data instead of duplicate data may be selected using other data attributes or according to other criteria.

For example, for a 2K version (as well as for the 4K version), parity data instead of duplicate data may be stored as the redundant data.

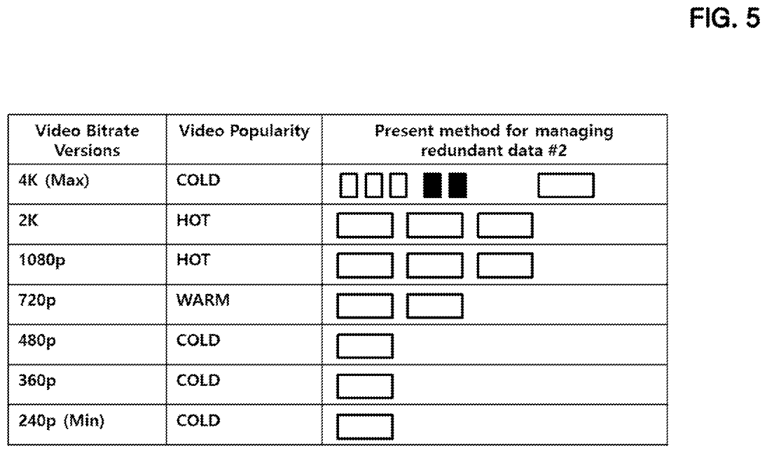

FIG. 5 illustrates a method for managing redundant data according to another embodiment of the present disclosure.

Unlike the embodiment of FIG. 4, in the embodiment of FIG. 5, duplicate data may be additionally stored as redundant data for the data for which parity data is stored as redundant data.

When the duplicate data is additionally stored as the redundant data, overhead due to a decoding operation during a data recovery operation can often be overcome. Also, in embodiments, the number of duplicate data stored with the parity data may be determined according to the popularity of the data.

Although various embodiments have been illustrated and described, various changes and modifications may be made to the described embodiments without departing from the spirit and scope of the invention as defined by the following claims.

What is claimed is:

1. A data storage system comprising:
a disk array including a plurality of disks and storing original data and redundant data used to recover the original data;
an interface circuit configured to receive a read request for the original data;
an input/output (I/O) control circuit configured to provide the disk array with a read request received via the interface circuit;
a redundant data management circuit configured to manage information of the original data and the redundant data,
wherein the redundant data management circuit is configured to:
store parity data, duplicate data, or both as the redundant data according to a first attribute of the original data, and
determines a number of the duplicate data according to a second attribute of the original data.

2. The data storage system of claim 1, wherein the first attribute includes a bitrate, and
wherein the redundant data management circuit stores the parity data as the redundant data when the bitrate of the original data corresponds is greater than or equal to a predetermined bitrate.

3. The data storage system of claim 2, wherein the parity data is generated using a plurality of partitions of the original data, and wherein the plurality of partitions of the original data and the parity data are stored in the plurality of disks.

4. The data storage system of claim 2, wherein the redundant data management circuit stores both the parity data and the duplicate data as the redundant data when the bitrate of the original data is greater than or equal to the predetermined bitrate.

5. The data storage system of claim 2, wherein the redundant data management circuit further stores the duplicate data as the redundant data when a bitrate of the original data is less than the predetermined bitrate.

6. The data storage system of claim 1, wherein the second attribute includes a popularity, and
wherein the redundant data management circuit is configured to determine the popularity according to a number of read requests during a predetermined period of time.

7. The data storage system of claim 1, further comprising a data recovery circuit configured to generate recovery data corresponding to the original data when a read error is detected for a read request provided from the I/O control circuit.

8. The data storage system of claim 7, wherein the data recovery circuit stores the recovery data as the original data and the redundant data management circuit updates location information in the disk array of the original data.

9. A method of operating a data storage system, the method comprising:
storing original data in the data storage system;
selecting parity data, duplicate data, or both as redundant data according to a first attribute of the original data;
determining a number of duplicate data according to a second attribute of the original data;
storing the redundant data in the data storage system; and
recovering the original data using the redundant data.

10. The method of claim 9, further comprising determining a popularity of the original data according to a number of read requests for the original data during a predetermined period time, wherein the second attribute includes the popularity.

11. The method of claim 9, wherein the first attribute includes a bitrate, and
wherein selecting the parity data, the duplicate data, or both includes selecting the parity data as the redundant data when the bitrate of the original data is greater than or equal to a predetermined bitrate.

12. The method of claim 11,
wherein storing the original data includes storing a plurality of partitions of the original data; and
wherein storing the redundant data includes storing a plurality of partitions of the parity data.

13. The method of claim 11, wherein selecting the parity data, the duplicate data, or both includes selecting both the parity and the duplicate data when the bitrate of the original data is greater than or equal to a predetermined bitrate.

14. The method of claim 11, wherein selecting the parity data, the duplicate data, or both includes selecting the duplicate data as the redundant data when the bitrate of the original data is less than the predetermined bitrate.

15. The method of claim 14, wherein determining the number of duplicate data includes determining a larger number of duplicate data for the original data having a higher popularity.
